(19) United States
(12) Patent Application Publication
(10) Pub. No.: US 2020/0200885 A1
(43) Pub. Date: Jun. 25, 2020

(54) ULTRASONIC SENSOR

(71) Applicant: Murata Manufacturing Co., Ltd., Nagaokakyo-shi (JP)

(72) Inventor: Takehiro SATO, Nagaokakyo-shi (JP)

(21) Appl. No.: 16/804,080

(22) Filed: Feb. 28, 2020

Related U.S. Application Data
(63) Continuation of application No. PCT/JP2018/030840, filed on Aug. 21, 2018.

(30) Foreign Application Priority Data
Sep. 21, 2017 (JP) 2017-181380

(51) Int. Cl. G01S 7/521; G01S 15/931

(52) U.S. Cl. CPC G01S 7/521; G01S 2015/938; G01S 15/931

(57) ABSTRACT

An ultrasonic sensor includes a case including a bottom plate, and a piezoelectric vibrating element mounted on the bottom plate. The case includes an internal space defined by a recess extending downward toward the bottom plate. When viewed in a direction perpendicular or substantially perpendicular to the bottom plate, the internal space is shaped such that a longitudinal direction is parallel or substantially parallel to the bottom plate. The case includes a first portion with a cylindrical shape and a first length that is an outside diameter along the longitudinal direction, and a second portion with a cylindrical shape and a second length D2 that is an outside diameter along the longitudinal direction and is greater than the first length. A maximum length of a portion of the internal space inside the second portion along the longitudinal direction is greater than a maximum length of a port of the internal space inside the first portion along the longitudinal direction.

### CROSS REFERENCE TO RELATED APPLICATIONS

This application claims the benefit of priority to Japanese Patent Application No. 2017-181380 filed on Sep. 21, 2017 and is a Continuation Application of PCT Application No. PCT/JP2018/030840 filed on Aug. 21, 2018. The entire contents of each application are hereby incorporated herein by reference.

### BACKGROUND OF THE INVENTION

### 1. Field of the Invention

The present invention relates to an ultrasonic sensor.

### 2. Description of the Related Art

An ultrasonic sensor is mounted, for example, on the rear of a vehicle and used as a back sonar. In this case, the ultrasonic sensor transmits ultrasonic waves backward from the vehicle, and then receives the ultrasonic waves reflected and returned from an obstacle behind the vehicle. On the basis of data obtained by electrically processing the relationship between the transmitted and received ultrasonic waves, distance information can be determined. As data representing the positional relationship of the obstacle relative to the rear of the vehicle, the distance information described above can be used to control the driving of the vehicle. An exemplary ultrasonic sensor that can be used for such purposes is described in Japanese Unexamined Patent Application Publication No. 2002-209294.

A lack of vertical directivity in the ultrasonic sensor may cause erroneous detection of an unwanted object. To improve detection accuracy of the ultrasonic sensor, a further improvement in vertical directivity is required. The appearance or design of the ultrasonic sensor mounted, for example, on a vehicle is also an issue.

### SUMMARY OF THE INVENTION

Preferred embodiments of the present invention provide ultrasonic sensors each having improved vertical directivity without sacrificing the design of the ultrasonic sensors mounted, for example, on a vehicle.

An ultrasonic sensor according to a preferred embodiment of the present invention includes a cylindrical case including a bottom plate, and a piezoelectric vibrating element mounted on the bottom plate inside the case. The case includes an internal space that is a recess extending downward toward the bottom plate. When viewed in a direction perpendicular or substantially perpendicular to the bottom plate, the internal space has a longitudinal direction parallel or substantially parallel to the bottom plate. The case includes a first portion and a second portion. The first portion has a cylindrical or substantially cylindrical shape extending from the bottom plate in the direction perpendicular or substantially perpendicular to the bottom plate, and has a first length which is an outside diameter along the longitudinal direction. The second portion is disposed on a side of the first portion remote from the bottom plate, has a cylindrical or substantially cylindrical shape concentric with the first portion, and has a second length which is an outside diameter along the longitudinal direction and is greater than the first length. A maximum length of a portion of the internal space inside the second portion along the longitudinal direction is greater than a maximum length of a portion of the internal space inside the first portion along the longitudinal direction.

Preferred embodiments of the present invention make it possible to improve vertical directivity without sacrificing the design of the ultrasonic sensor mounted, for example, on a vehicle.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a first perspective view of an ultrasonic sensor according to a first preferred embodiment of the present invention.

FIG. 2 is a second perspective view of the ultrasonic sensor according to the first preferred embodiment of the present invention.

FIG. 3 is a cross-sectional view of the ultrasonic sensor according to the first preferred embodiment of the present invention.

FIG. 4 is a perspective view of a case included in the ultrasonic sensor according to the first preferred embodiment of the present invention.

FIG. 5 is a first plan view of the case included in the ultrasonic sensor according to the first preferred embodiment of the present invention.

FIG. 6 is a second plan view of the case included in the ultrasonic sensor according to the first preferred embodiment of the present invention.

FIG. 7 is a cross-sectional view as viewed in the direction of arrow VII-VII in FIG. 6.

FIG. 8 is a cross-sectional view as viewed in the direction of arrow VIII-VIII in FIG. 6.

FIG. 9 is an explanatory diagram of a portion defining and functioning as a vibrating surface in the ultrasonic sensor according to the first preferred embodiment of the present invention.

FIG. 10 is a graph showing vertical directivities of a conventional ultrasonic sensor and the ultrasonic sensor according to the first preferred embodiment of the present invention.

FIG. 11 is an explanatory diagram illustrating how the ultrasonic sensor according to the first preferred embodiment of the present invention is mounted and used on the rear of a vehicle.

FIG. 12 is a perspective view of an ultrasonic sensor according to a second preferred embodiment of the present invention.

FIG. 13 is a plan view of a case included in the ultrasonic sensor according to the second preferred embodiment of the present invention.

FIG. 14 is a cross-sectional view as viewed in the direction of arrow XIV-XIV in FIG. 13.

FIG. 15 is a cross-sectional view as viewed in the direction of arrow XV-XV in FIG. 13.

FIG. 16 is a perspective view of an ultrasonic sensor according to a third preferred embodiment of the present invention.

FIG. 17 is a plan view of a case included in the ultrasonic sensor according to the third preferred embodiment of the present invention.

FIG. 18 is a cross-sectional view as viewed in the direction of arrow XVIII-XVIII in FIG. 17.

FIG. 19 is a cross-sectional view as viewed in the direction of arrow XIX-XIX in FIG. 17.

FIG. 20 is a perspective view of an ultrasonic sensor according to a fourth preferred embodiment of the present invention.

FIG. 21 is a plan view of a case included in the ultrasonic sensor according to the fourth preferred embodiment of the present invention.

FIG. 22 is a cross-sectional view as viewed in the direction of arrow XXII-XXII in FIG. 21.

FIG. 23 is a cross-sectional view as viewed in the direction of arrow XXIII-XXIII in FIG. 21.

FIG. 24 is a cross-sectional view of an ultrasonic sensor according to a fifth preferred embodiment of the present invention.

### DETAILED DESCRIPTION OF THE PREFERRED EMBODIMENTS

Preferred embodiments of the present invention will be described in detail with reference to the drawings.

Dimensions in the drawings are not necessarily to scale and may be exaggerated for convenience of explanation. In the following description, the concept of “up” or “down” does not necessarily mean “up” or “down” in an absolute sense, and may mean “up” or “down” in a relative sense in the illustrated position.

### First Preferred Embodiment

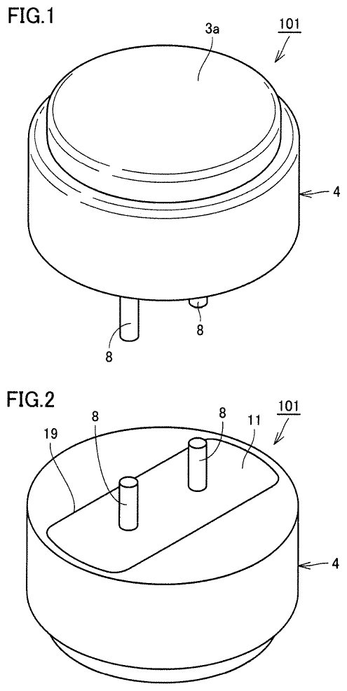

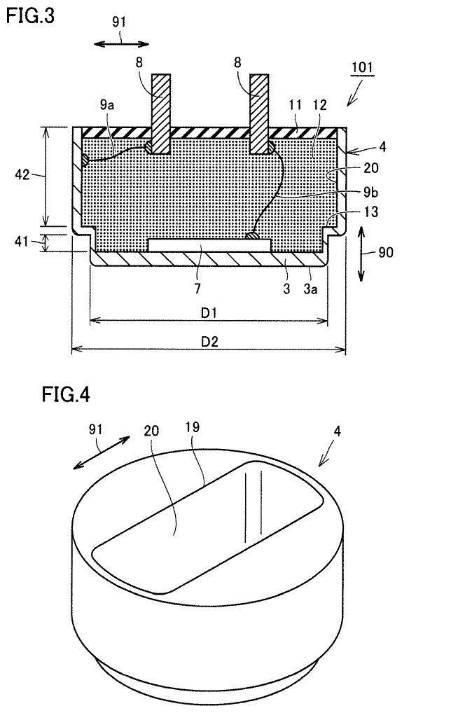

With reference to FIG. 1 to FIG. 8, an ultrasonic sensor according to a first preferred embodiment of the present invention will be described. FIG. 1 illustrates an outer appearance of an ultrasonic sensor 101 according to the present preferred embodiment. The ultrasonic sensor 101 includes a case 4 and two external terminals 8 protruding from the case 4. The case 4 includes a front surface 3a. The front surface 3a preferably has, for example, a circular or substantially circular shape. FIG. 2 illustrates a back side of the ultrasonic sensor 101. The case 4 includes an opening 19. The opening 19 is closed by a lid 11. FIG. 3 is a cross-sectional view of the ultrasonic sensor 101. The two external terminals 8 are positioned to protrude out of a filling material 12. The two external terminals 8 each pass through the lid 11. The case 4 is preferably made of, for example, of metal. The case 4 is formed, for example, in an integrated manner. The case 4 includes a bottom plate 3, and the front surface 3a visible in FIG. 1 includes the outer surface of the bottom plate 3.

The ultrasonic sensor 101 includes the case 4 cylindrically or substantially cylindrically shaped and including the bottom plate 3, and a piezoelectric vibrating element 7 mounted on the bottom plate 3 inside the case 4. The case 4 includes an internal space 20 which is a recess extending downward toward the bottom plate 3. The internal space 20 is filled with the filling material 12. The internal space 20 is closed by the lid 11. The lid 11 is preferably made of, for example, an insulator. The internal space 20 is filled with the filling material 12. As illustrated in FIG. 3, one of the two external terminals 8 is electrically connected to the case 4 by a lead wire 9a, and the other of the two external terminals 8 is electrically connected to the piezoelectric vibrating element 7 by a lead wire 9b. While not illustrated in detail in FIG. 3, the piezoelectric vibrating element 7 actually includes two electrodes. Of the two electrodes of the piezoelectric vibrating element 7, one is electrically connected to the lead wire 9b, and the other is electrically connected to the bottom plate 3 of the case 4.

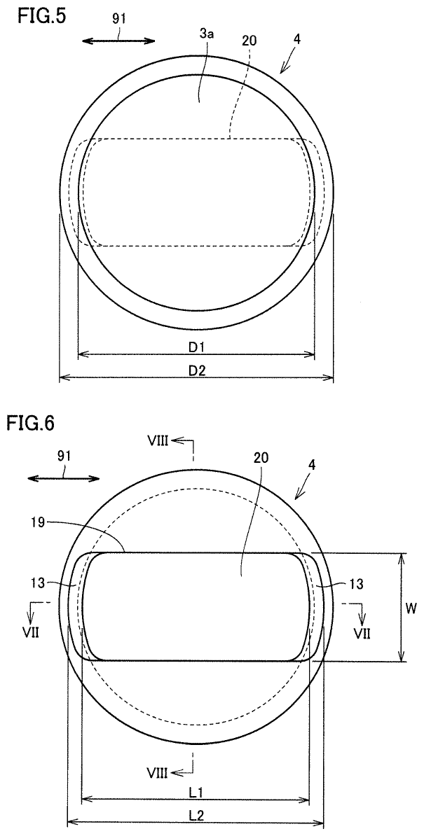

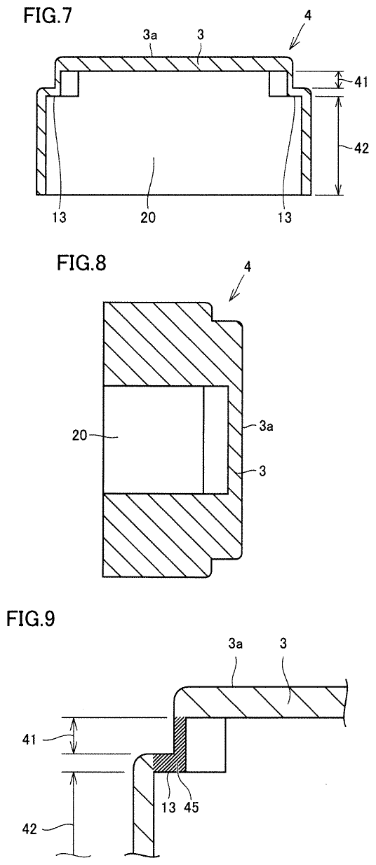

FIG. 4 illustrates the case 4 t independently. FIG. 5 illustrates the case 4 as viewed from the front surface 3a. When the case 4 is viewed in a direction 90 perpendicular or substantially perpendicular to the bottom plate 3, the internal space 20 is shaped such that a longitudinal direction 91 is parallel or substantially parallel to the bottom plate 3. FIG. 6 illustrates the case 4 as viewed from the opening 19. FIG. 7 is a cross-sectional view as viewed in the direction of arrow VII-VII in FIG. 6. FIG. 8 is a cross-sectional view as viewed in the direction of arrow VIII-VIII in FIG. 6.

The case 4 includes a first portion 41 and a second portion 42. The first portion 41 has a cylindrical or substantially cylindrical shape extending from the bottom plate 3 in the direction 90 perpendicular or substantially perpendicular to the bottom plate 3, and has a first length D1 which is an outside diameter along the longitudinal direction 91. The second portion 42 is disposed on a side of the first portion 41 remote from the bottom plate 3, has a cylindrical or substantially cylindrical shape concentric with the first portion 41, and has a second length D2 which is an outside diameter along the longitudinal direction 91 and is greater than the first length D1. As illustrated in FIG. 6, a maximum length L2 of a portion of the internal space 20 inside the second portion 42 along the longitudinal direction 91 is greater than a maximum length L1 of a portion of the internal space 20 inside the first portion 41 along the longitudinal direction 91.

The bottom plate 3 defines and functions as a vibrating plate. The piezoelectric vibrating element 7 vibrates in response to an electric signal applied to the piezoelectric vibrating element 7. Vibration produced by the piezoelectric vibrating element 7 vibrates the bottom plate 3 and sends out ultrasonic waves from the front surface 3a. Ultrasonic waves coming from outside onto the front surface 3a vibrate the bottom plate 3. By the piezoelectric vibrating element 7, this vibration can be detected as an electric signal.

The present preferred embodiment improves the vertical directivity provided by the conventional structure. That is, the present preferred embodiment is able to narrow the angular range which allows high-sensitivity sensing. The reasons for this will be described in detail below.

To improve vertical directivity, L1 is preferably increased as much as possible. In the conventional structure, that is, in the structure where L1 and L2 of the internal space 20 are equal, the vertical directivity is dependent on L1. L1 is a dimension obtained by subtracting a value twice the thickness of the outer wall of the first portion 41 from D1, which is the diameter of the first portion 41 along the longitudinal direction 91. This means that the vertical directivity is dependent on the outer shape of the first portion 41. The outer shape of the first portion 41 cannot be expanded due to limitations associated with, for example, space to install the ultrasonic sensor. The upper limit of D1 is thus determined. Since the upper limit of L1 is dependent on the upper limit of D1, there has been a limit to the extent to which the vertical directivity of the ultrasonic sensor can be improved.

However, in the present preferred embodiment, where L1 and L2 have different values and L2 is greater than L1, it is possible to increase L2 without changing L1. Therefore, for example, even when D1 is dependent on the space to install the ultrasonic sensor and this determines the upper limit of L1, it is still possible to increase L2. In the present preferred embodiment, a portion 45 illustrated in FIG. 9 defines and functions as a vibrating surface, along with the bottom plate 3. In FIG. 9, the portion 45 is densely hatched for convenience of explanation. The portion 45 is defined by of the outer wall of the first portion 41 and a portion of a stepped portion 13 parallel or substantially parallel to the bottom plate 3. An imaginary surface surrounded by the outer wall of the second portion 42 and parallel or substantially parallel to the bottom plate 3 can be regarded as a pseudo vibrating surface. The maximum internal length of the second portion 42 along the longitudinal direction 91 is L2. The vertical directivity can thus be determined by L2, which is greater than L1. The vertical directivity provided by the conventional structure can thus be improved.

When mounted on, for example, a vehicle, the ultrasonic sensor is typically attached to a bumper, with only the front surface 3a of the bottom plate 3 exposed through a hole in the bumper. Therefore, to discuss the design of the ultrasonic sensor mounted on the vehicle, the diameter of the front surface 3a is taken into account. In the present preferred embodiment, where there is no need to change D1 to increase L2, the diameter of the front surface 3a is able to be maintained unchanged. The present preferred embodiment can thus improve vertical directivity without sacrificing the design of the ultrasonic sensor mounted on the vehicle.

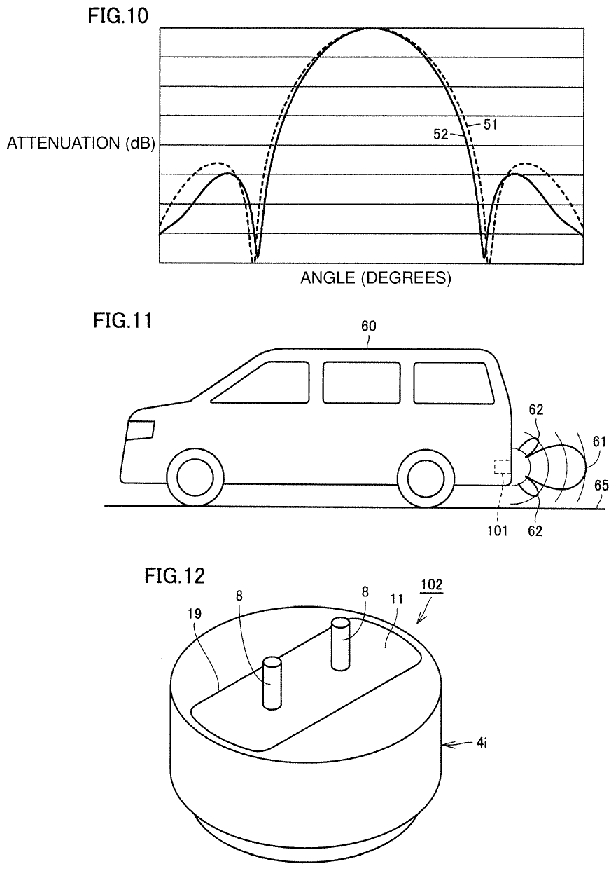

FIG. 10 is a graph that compares vertical directivities of an ultrasonic sensor having the conventional structure and the ultrasonic sensor 101 according to the present preferred embodiment. A line 51 represents a vertical directivity obtained by the ultrasonic sensor having the conventional structure. A line 52 represents a vertical directivity obtained by the ultrasonic sensor 101 according to the present preferred embodiment. FIG. 11 illustrates an example of how the ultrasonic sensor 101 is mounted and used on the rear of a vehicle 60. A main lobe 61 and side lobes 62 are shown in FIG. 11. The ultrasonic sensor 101 is expected to appropriately detect an obstacle behind the vehicle 60, but is expected not to detect a ground 65. The main lobe 61 and the side lobes 62 each represent a range where an object can be detected with ultrasonic waves. In FIG. 10, three bumps appear in both the line 51 and the line 52. Of the three bumps in FIG. 10, the bump in the center corresponds to the main lobe 61 and the lower bumps on both sides correspond to the side lobes 62. The narrower the width of the bump corresponding to the main lobe 61, the better. FIG. 10 shows that in the line 52, the width of the bump corresponding to the main lobe 61 is narrower than that in the line 51. This means that the main lobe 61 is narrowed and vertical directivity is improved. To prevent the ultrasonic sensor 101 from erroneously detecting ultrasonic waves reflected, for example, from the ground 65 in FIG. 11, it is preferable that the bumps corresponding to the side lobes 62 are small. In FIG. 10, the lower the bumps corresponding to the side lobes 62, the better. FIG. 10 shows that in the line 52, the bumps corresponding to the side lobes 62 are lower than those in the line 51. This means that with the ultrasonic sensor 101 according to the present preferred embodiment, the side lobes 62 are reduced and vertical directivity is improved.

As described in the present preferred embodiment, the portion of the internal space 20 inside the first portion 41 and the portion of the internal space 20 inside the second portion 42 preferably define the stepped portions 13 at respective ends of the internal space 20 in the longitudinal direction 91. This configuration enables an abrupt change in the internal shape in the area of transition from the first portion 41 to the second portion 42. This can connect the first portion 41 and the second portion 42 even if there is a significant difference between L1 and L2.

As described in the present preferred embodiment, when viewed in the direction 90 perpendicular or substantially perpendicular to the bottom plate 3, the contour of the internal space 20 is preferably curved along the contour of the case 4 at both ends of the internal space 20 in the longitudinal direction 91. This configuration can expand the vibration of the piezoelectric vibrating element 7 in the longitudinal direction 91, and can narrow the vertical directivity as a result.

Although the present preferred embodiment shows an example where the internal space 20 is entirely or substantially entirely filled with the filling material 12 of one type, this is merely an example. The internal space 20 may be filled with two or more types of materials combined together. The internal space 20 is not necessarily required to be entirely or substantially entirely filled with the filling material 12, and may be partially filled with the filling material 12.

As described in the present preferred embodiment, the filling material 12 preferably fills at least a portion of the internal space 20. This configuration protects the piezoelectric vibrating element 7. Depending on how the filling material 12 is disposed, it is possible to reduce or prevent entry of water or dust particles into the area around the piezoelectric vibrating element 7. The filling material 12 may preferably be, for example, silicone.

Although the opening 19 is closed by the lid 11 in the present preferred embodiment, the lid 11 is optional and the ultrasonic sensor may not include the lid 11. Also, the internal space 20 is not necessarily required to be filled with the filling material 12. These conditions are also applicable to the preferred embodiments described below.

### Second Preferred Embodiment

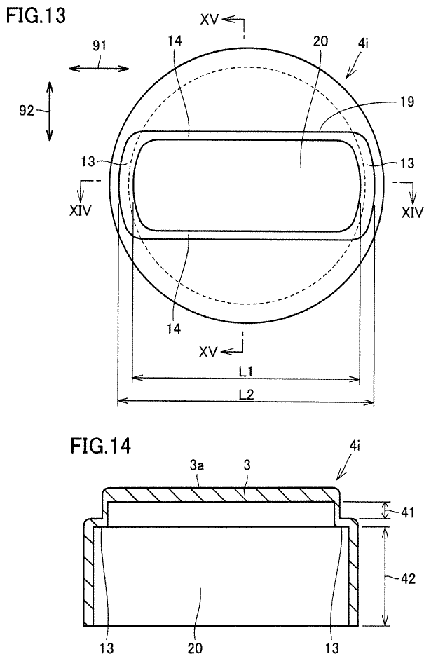

With reference to FIG. 12 to FIG. 15, an ultrasonic sensor according to a second preferred embodiment of the present invention will be described. FIG. 12 illustrates an outer appearance of an ultrasonic sensor 102 according to the present preferred embodiment. The ultrasonic sensor 102 includes a case 4i and two external terminals 8 protruding from the case 4i. FIG. 13 is a plan view of the case 4i. FIG. 14 is a cross-sectional view as viewed in the direction of arrow XIV-XIV in FIG. 13. FIG. 15 is a cross-sectional view as viewed in the direction of arrow XV-XV in FIG. 13.

Similar to the case 4 described in the first preferred embodiment, the case 4i is preferably made of, for example, of metal. The same applies to other cases described in the following preferred embodiments. Similar to the case 4 described in the first preferred embodiment, the case 4i includes the first portion 41 and the second portion 42. As illustrated in FIG. 13, the maximum length L2 of a portion of the internal space 20 inside the second portion 42 along the longitudinal direction 91 is greater than the maximum length L1 of a portion of the internal space 20 inside the first portion 41 along the longitudinal direction 91. The portion of the internal space 20 inside the first portion 41 and the portion of the internal space 20 inside the second portion 42 define the stepped portions 13 at respective ends of the internal space 20 in the longitudinal direction 91. When a direction perpendicular or substantially perpendicular to the longitudinal direction 91 is defined as a width direction 92, the portion of the internal space 20 inside the first portion 41 and the portion of the internal space 20 inside the second portion 42 define stepped portions 14 at respective ends of the internal space 20 in the width direction 92. Two sides of the stepped portions 14 are linear. The two sides of the stepped portions 14 are parallel or substantially parallel to the longitudinal direction 91. The stepped portions 13 and the stepped portions 14 may be continuous, as illustrated in FIG. 13.

The present preferred embodiment achieves advantageous effects the same as or similar to those of the first preferred embodiment.

### Third Preferred Embodiment

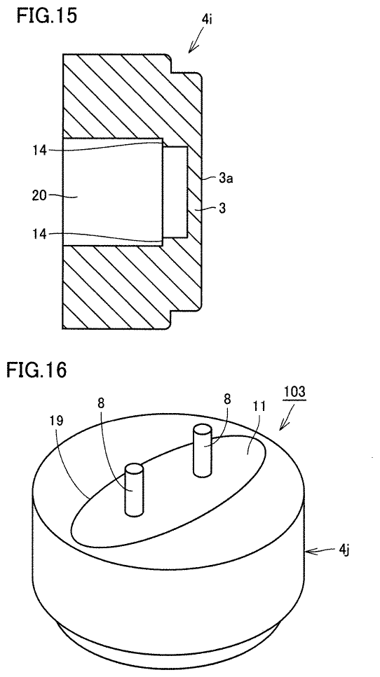

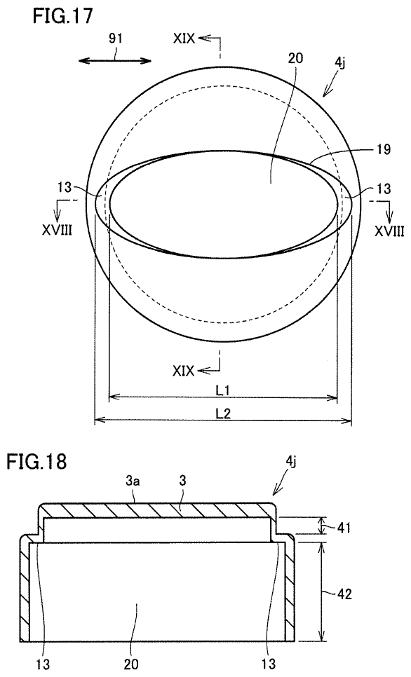

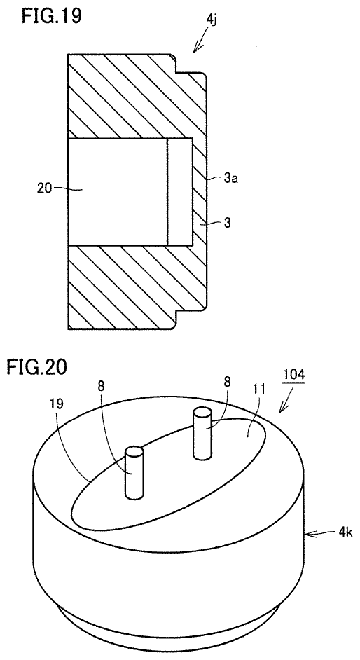

With reference to FIG. 16 to FIG. 19, an ultrasonic sensor according to a third preferred embodiment of the present invention will be described. FIG. 16 illustrates an outer appearance of an ultrasonic sensor 103 according to the present preferred embodiment. The ultrasonic sensor 103 includes a case 4j and two external terminals 8 protruding from the case 4j. FIG. 17 is a plan view of the case 4j. FIG. 18 is a cross-sectional view as viewed in the direction of arrow XVIII-XVIII in FIG. 17. FIG. 19 is a cross-sectional view as viewed in the direction of arrow XIX-XIX in FIG. 17.

Similar to the case 4 described in the first preferred embodiment, the case 4j includes the first portion 41 and the second portion 42. As illustrated in FIG. 17, the maximum length L2 of a portion of the internal space 20 inside the second portion 42 along the longitudinal direction 91 is greater than the maximum length L1 of a portion of the internal space 20 inside the first portion 41 along the longitudinal direction 91. As illustrated in FIG. 17, the internal space 20 has an elliptical or substantially elliptical shape when viewed in the direction perpendicular or substantially perpendicular to the bottom plate 3. The portion of the internal space 20 inside the first portion 41 and the portion of the internal space 20 inside the second portion 42 define the stepped portions 13 at respective ends of the internal space 20 in the longitudinal direction 91.

The present preferred embodiment achieves advantageous effects the same as or similar to those of the first preferred embodiment.

### Fourth Preferred Embodiment

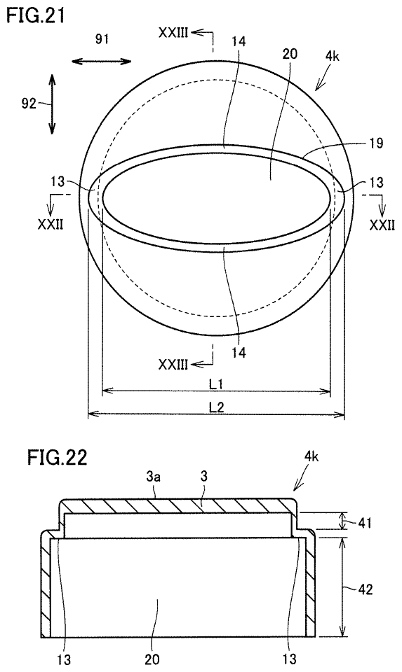

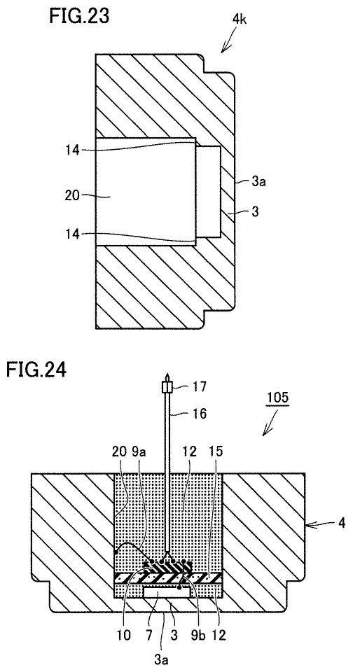

With reference to FIG. 20 to FIG. 23, an ultrasonic sensor according to a fourth preferred embodiment of the present invention will be described. FIG. 20 illustrates an outer appearance of an ultrasonic sensor 104 according to the present preferred embodiment. The ultrasonic sensor 104 includes a case 4k and two external terminals 8 protruding from the case 4k. FIG. 21 is a plan view of the case 4k. FIG. 22 is a cross-sectional view as viewed in the direction of arrow XXII-XXII in FIG. 21. FIG. 23 is a cross-sectional view as viewed in the direction of arrow XXIII-XXIII in FIG. 21.

Similar the case 4 described in the first preferred embodiment, the case 4k includes the first portion 41 and the second portion 42. As illustrated in FIG. 21, the maximum length L2 of a portion of the internal space 20 inside the second portion 42 along the longitudinal direction 91 is greater than the maximum length L1 of a portion of the internal space 20 inside the first portion 41 along the longitudinal direction 91. As illustrated in FIG. 21, the internal space 20 has an elliptical or substantially elliptical shape when viewed in the direction perpendicular or substantially perpendicular to the bottom plate 3. The portion of the internal space 20 inside the first portion 41 and the portion of the internal space 20 inside the second portion 42 define the stepped portions 13 at respective ends of the internal space 20 in the longitudinal direction 91. The portion of the internal space 20 inside the first portion 41 and the portion of the internal space 20 inside the second portion 42 define the stepped portions 14 at respective ends of the internal space 20 in the width direction 92. The stepped portions 13 and the stepped portions 14 may be continuous, as illustrated in FIG. 21.

The present preferred embodiment achieves advantageous effects the same as or similar to those of the first preferred embodiment.

Of the four configurations of the first to fourth preferred embodiments described above, the configuration of the first preferred embodiment is particularly preferable. That is, as in the first preferred embodiment, when viewed in the direction perpendicular or substantially perpendicular to the bottom plate 3, it is preferable that the internal space 20 includes two sides parallel or substantially parallel to the longitudinal direction 91, and that between the two sides, the width of the portion of the internal space 20 inside the first portion 41 is equal or substantially equal to the width of the portion of the internal space 20 inside the second portion 42. In the example illustrated in FIG. 6, the two widths are both W.

### Fifth Preferred Embodiment

With reference to FIG. 24, an ultrasonic sensor according to a fifth preferred embodiment of the present invention will be described. FIG. 24 is a cross-sectional view of an ultrasonic sensor 105 according to the present preferred embodiment. The ultrasonic sensor 105 includes the case 4 and one lead wire 16 protruding from the case 4. The piezoelectric vibrating element 7 is mounted on the bottom plate 3 of the case 4. The internal space 20 of the case 4 is divided into three layers. The layer closest to the bottom plate 3 is filled with the filling material 12. The filling material 12 may preferably be, for example, silicone. A sound-absorbing material 15 is disposed in the layer second closest to the bottom plate 3. A substrate 10 is disposed on the surface of the sound-absorbing material 15. The layer farthest from the bottom plate 3 is filled with the filling material 12. The sound-absorbing material 15 may preferably be, for example, either felt or silicone sponge. A portion of the lead wire 16 is disposed in the internal space 20 of the case 4, and the other portion of the lead wire 16 extends out of the case 4. The lead wire 16 is electrically connected at one end thereof to the substrate 10. The portion of the lead wire 16 connected to the substrate 10 is covered with the filling material 12. The lead wire 16 is provided with a connector 17 at the other end thereof. The lead wire 16 includes at least two wires therein. A first wire on the surface of the substrate 10 is connected to the case 4 by the lead wire 9a, and a second wire on the surface of the substrate 10 is connected to the piezoelectric vibrating element 7 by the lead wire 9b. As in the example illustrated in FIG. 24, the lid 11 may not be provided and the upper surface of the filling material 12 may be directly exposed to the outside. Alternatively, a lid may cover the upper surface of the filling material 12.

The present preferred embodiment achieves advantageous effects the same as or similar to those of the first preferred embodiment. With the sound-absorbing material 15 disposed in the internal space 20 as described in the present preferred embodiment, for example, back radiation from the piezoelectric vibrating element 7 can be reduced and a dereverberation effect can be achieved.

Some of the preferred embodiments described above may be appropriately used in combination.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ultrasonic sensor comprising:
a cylindrical case including a bottom plate; and
a piezoelectric vibrating element mounted on the bottom plate inside the case; wherein
the case includes an internal space defined by a recess extending downward toward the bottom plate;
when viewed in a direction perpendicular or substantially perpendicular to the bottom plate, the internal space is shaped such that a longitudinal direction extends parallel or substantially parallel to the bottom plate;
the case includes:
a first portion having a cylindrical shape extending from the bottom plate in the direction perpendicular or substantially perpendicular to the bottom plate, the first portion having a first length defined by an outside diameter along the longitudinal direction; and
a second portion disposed on a side of the first portion remote from the bottom plate, having a cylindrical shape concentric with the first portion, and having a second length defined by an outside diameter along the longitudinal direction, the second length being greater than the first length; and
a maximum length of a portion of the internal space inside the second portion along the longitudinal direction is greater than a maximum length of a portion of the internal space inside the first portion along the longitudinal direction.

2. The ultrasonic sensor according to claim 1, wherein the portion of the internal space inside the first portion and the portion of the internal space inside the second portion define stepped portions at respective ends of the internal space in the longitudinal direction.

3. The ultrasonic sensor according to claim 1, wherein when viewed in the direction perpendicular or substantially perpendicular to the bottom plate, a contour of the internal space is curved along a contour of the case at both ends of the internal space in the longitudinal direction.

4. The ultrasonic sensor according to claim 1, wherein a filling material fills at least a portion of the internal space.

5. The ultrasonic sensor according to claim 1, wherein when viewed in the direction perpendicular or substantially perpendicular to the bottom plate, the internal space includes two sides parallel or substantially parallel to the longitudinal direction and, between the two sides, the portion of the internal space inside the first portion has a same width as that of the portion of the internal space inside the second portion.

6. The ultrasonic sensor according to claim 1, further comprising a lid covering the internal space.

7. The ultrasonic sensor according to claim 6, further comprising two external terminals extending from the internal space through the lid.

8. The ultrasonic sensor according to claim 1, wherein the cylindrical case is made of metal.

9. The ultrasonic sensor according to claim 4, wherein the filling material is silicone.

10. The ultrasonic sensor according to claim 1, wherein when viewed in the direction perpendicular or substantially perpendicular to the bottom plate, the internal space includes two sides parallel or substantially parallel to the longitudinal direction and, between the two sides, the portion of the internal space inside the first portion has a width greater than that of the portion of the internal space inside the second portion.

11. The ultrasonic sensor according to claim 1, wherein the internal space has an elliptical or substantially elliptical shape.

12. The ultrasonic sensor according to claim 6, wherein the lid is made of an insulator.

13. The ultrasonic sensor according to claim 1, wherein the bottom plate defines and functions as a vibrating plate.

14. The ultrasonic sensor according to claim 1, wherein
the internal space includes first, second, and third layers;
the first layer is disposed closest to the bottom plate and is filled with a filling material;
the second layer is disposed on the first layer and is filled with a sound-absorbing material; and
the third layer is disposed on the second layer and is filled with the filling material.

15. The ultrasonic sensor according to claim 14, wherein the sound-absorbing material is at least one of felt and silicone felt.

16. The ultrasonic sensor according to claim 14, wherein the filling material is made of silicone.
